(19) United States
(12) Patent Application Publication
(10) Pub. No.: US 2007/0200532 A1
(43) Pub. Date: Aug. 30, 2007

(54) Electric automobile/special power source

(76) Inventor: Wallace William Vaux, Blaine, WA (US)

Correspondence Address: WALLACE WILLIAM VAUX, 6947 Birch Bay Drive, Blaine, WA, 98230, US

(21) Appl. No.: 11/355,403

(22) Filed: Feb. 16, 2006

(51) Int. Cl. H02J 7/00

(52) U.S. Cl. 320/104

(57) ABSTRACT

The Electric Automobile/Special Power-Source is a new concept which derives its superior performance of a quick battery change from dead 12-volt cells by extracting 4-5 cell Bat-Pac's from 4 locations. Timeframe is hopefully from 15-20 minutes. A normal charge time for lead-acid batteries is from 6 to 8 hours. Therefore, a customer drives onto the change stall and out comes one 5 cell Bat-Pac and a fresh, fully-charged 5 cell Bat-Pac is reinserted into the compartment. Electric Automobile/Special Power Source positions forward to extract the second 5 cell Bat-Pac. A fully-charged 5 cell Bat-Pac is positioned into that compartment. The two forward compartments are unloaded-loaded from the side by a hydraulic ram. Electric Automobile/Special Power Source then drives off the stall and circles the Control Center to position over the rear end bottom feed extraction/load pit.

The same maneuver or extraction service is-performed except a hydraulic hoist lowers and hoists the Bat-Pac's from below from a roller assemblage.

All the Bat-Pac's are transferred over belt-roller systems. Dead Bat-Pac units are belt and roller transferred to two charging floors. When fully charged they are transferred to the storage floor on the Main Floor or onto the Basement Storage Area. The Electric Automobile/Special Power Source is owned by the customer. The Bat-Pac's are owned by Mar-Wall Motors, Inc. At this time, Mar-Wall Motors, Inc. is a private company.

The company charges the customer a fee for the Bat-Pac X-change which will include power costs, maintenance, depreciation plus a profit. Simplicity makes this invention. The above service is performed by an attendant from the Control Room.

The system for powet to the Bat-Pac's can also be plugged into a home charger-converter which changes 120 VAC into 12 VDC. This enables a complete overnight charge while parked in your garage.

### FIELD OF THE INVENTION AND BACKGROUND

This invention is a newer and revised version of replacing discharged battery pac's in electric powered vehicles. It should be more efficient and practical and reduce a long charge time and wait for new fuel replacement battery pac's.

Prior electric vehicle science did not include battery pac transfer out and in until recent years. This totally will enable electric driven vehicles to operate in competition with fossil fuel powered vehicles. The electric auto era is fast approaching and can only prove more efficient and be more effective in less fuel emissions.

### SUMMARY OF THE INVENTION

This invention allows for an immediate battery recharge to the battery power source without a 6-8 hour time elapse. Today there is an immediate recharge to the electric auto battery power source. This is a very safe, easy, quick disconnect-connect feature. Four-5 regular lead-acid battery 12-volt Bat-Pac's are disconnected and withdrawn and sent by conveyor system to a Recharge Department. Fully recharged battery Bat-Pac's that have been in storage are conveyed to the auto and installed immediately. This has been designed to be accomplished in a similar timeframe as fueling your gas-powered auto at a gasoline filling station.

The springloaded connect-disconnect terminals are very rugged and allow for a very efficient access to power and transfer of energy where needed.

The belt-roller transfer system is very well designed and allows for Bat-Pac's to proceed from the Electric Automobile/Special Power Source to charge lines on Second floor. From reaching a charge they can either be transferred direct to a positioned Electric Automobile/Special Power Source or to the main floor storage. After withdraw from Electric Automobile/Special Power Source some Bat-Pac's enter a charge or store area in the building basement. All of this activity is controlled from the Conrol Room by an attendant. The attendant also is in charge of helping position the Electric Automobile/Special Power Source from the Control Room with electronic positioning sensors that help guide the driver to the proper X-change position.

The system for power to the Bat-Pac's can also be plugged into a home charger-converter which changes 120 VAC into 12 VDC. This enables a complete overnight charge while parked in your garage.

### BRIEF DESCRIPTION OF THE DRAWINGS

FIG. 1. A view of Electric Automobile/Special Power Source

FIG. 2. Another view of Electric Automobile/Special Power Source

FIG. 3. A view of the Control Center and attendant controls which function from this site.

3A-1, This view shows front change monitor, gauges and

3A-2, switch controls.

3B-1, This view shows rear change monitors, gauges and

3B-2, switch controls.

3C-1, This is a view of the approach sensor

3C-2, monitoring

3C-3. design.

FIG. 4. This is a view of a withdrawal of a Bat-Pac. It has a second view which shows replacing a fresh, charged

4A, Bat-Pac in Electric Automobile/Special Power Supply

4B side exchange.

FIG. 5. A similar 2-step procedure is viewed for the second Bat-Pac. Side exchange.

5A.

5B.

FIG. 6. This view documents the 2nd floor charging stations. Side access.

FIG. 7. This view shows the storage area on the Main Floor for Bat-Pac's. These are from the front positions only.

FIG. 8. A view of receiving on the belt roller system recharged Bat-Pac's from side exchange.

FIG. 9. A view showing the unload-reload process for the

A, 2 bottom access Bat-Pac's.

B,

C,

D.

FIG. 10. This view shows the 2nd floor charging stations for the 2 bottom access Bat-Pac's.

FIG. 11. This view positions bottom access Bat-Pac's in Main Floor Storage.

FIG. 12. This view routes the return from storage of bottom access Bat-Pac's.

FIG. 13. This view locates all side-exchange Bat-Pac's that were routed to the basement charge-storage floor.

FIG. 14. This view locates all bottom access Bat-Pac's that were routed to the basement charge-storage area.

14A Overview of basement-1st floor-2nd floor & transfer facilities.

FIG. 15. This view shows detailed connect-disconnect terminals of side exchange system.

FIG. 16. This view shows detailed connect-disconnect terminals at bottom access Bat-Pac exchange system.

FIG. 17. This view details connect-disconnect terminals of side exchange charge stations.

FIG. 18. This view details connect-disconnect terminals of bottom access charge stations.

FIG. 19. Another view of Control Center with side extraction of Bat-Pac's. Also vertical extraction from bottom access. Hoist with Bat-Pac mounted on hoist.

FIG. 20. Same as 19 but at 90° angle. Also power roller mechanism and belt conveyors.

FIG. 21. Electric Automobile/Special Power Source positioned over vertical extraction hoist. Control Center in background. Also power rollers & conveyors shown.

FIG. 22. Another view of Electric Automobile/Special Power Source positioned over vertical hoist and with extraction of bottom access Bat-Pac's.

FIG. 23. Another view with Electric Automobile/Special Power Source positioned over vertical hoist. Also shows flow of Bat-Pac's , power rollers & belt transfers.

FIG. 24. Similar, with view showing Bat-Pac on hoist part way up to Bat-Pac compartment area of Electric Automobile/Special Power Source.

FIG. 25. Belt transfer ram with belt orientation. Also deflector which will help to orient Bat-Pac for charging station connectors.

### BELT & ROLLER IDENTIFICATION CODE

FRONT CHANGE

| | | |
|---|---|---|
| 212 | | 2nd floor transfer charge |
| 213 | | 2nd floor transfer charge |
| 112 | | 1st floor storage transfer |
| 113 | | 1st floor storage transfer |
| B-3 | | Basement transfer |
| B-4 | | Basement transfer |
| F-2-4 | | |
| F-2-3 | | |
| F-2-2 | {close oversize brace} | Front change (charge) |
| F-2-1 | | |
| F-1-4 | | |
| F-1-3 | | |
| F-1-2 | {close oversize brace} | Front change (storage) |
| F-1-1 | | |
| F-B-3 | | |
| F-B-2 | {close oversize brace} | Front change (charge & storage) |
| F-B-1 | | |

REAR CHANGE

| | | |
|---|---|---|
| 210 | | 2nd Floor transfer charge |
| 211 | | 2nd Floor transfer charge |
| 110 | | 1st Floor storage transfer |
| 111 | | 1st Floor storage transfer |
| B-1 | | Basement transfer |
| B-2 | | Basement transfer |
| R-2-4 | | |
| R-2-3 | | |
| R-2-2 | {close oversize brace} | Rear change (charge) |
| R-2-1 | | |
| R-1-4 | | |
| R-1-3 | | |
| R-1-2 | {close oversize brace} | Rear change (storage) |
| R-1-1 | | |
| R-B-4 | | |
| R-B-3 | | |
| R-B-2 | {close oversize brace} | Rear change (charge & storage) |
| R-B-1 | | |

The following are miscellaneous transfer rollers and belt assemblies. They all interconnect with the aforementioned process configurations.
49
50
51
52
53
54
55
56
57
58
59A
59B
60
61
62
114

### DETAILED DESCRIPTION OF THE PREFERRED EMBODIMENTS

In FIG. 1 we have the isometric view of the Electric Automobile/Special Power Source which is a battery powered electric vehicle (10).

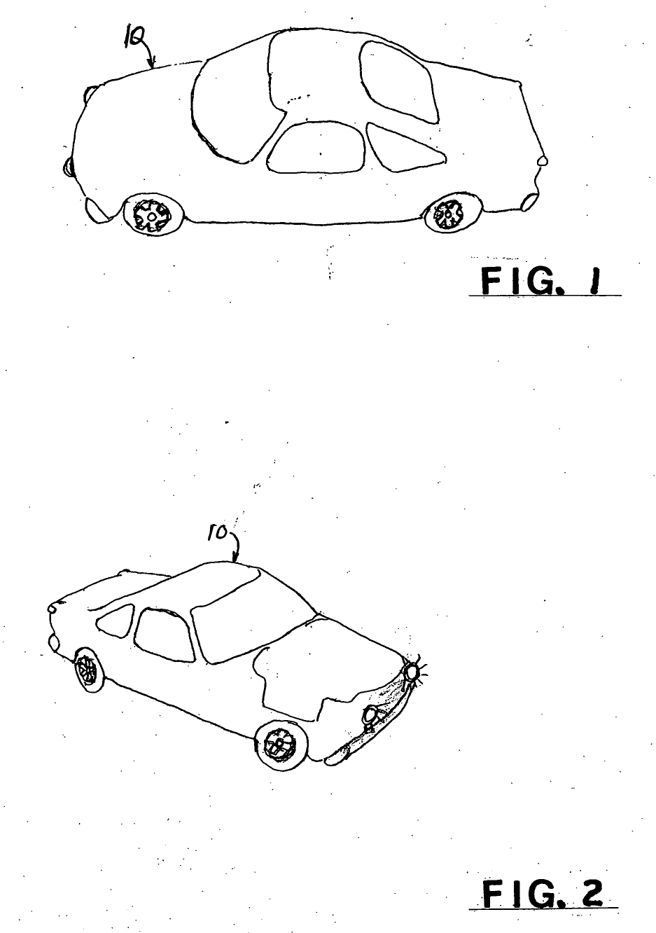

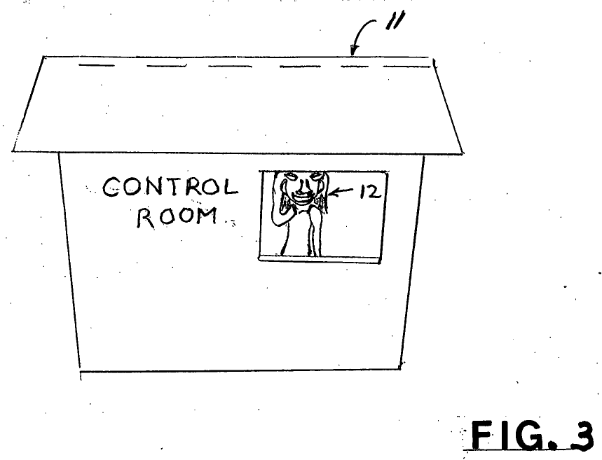

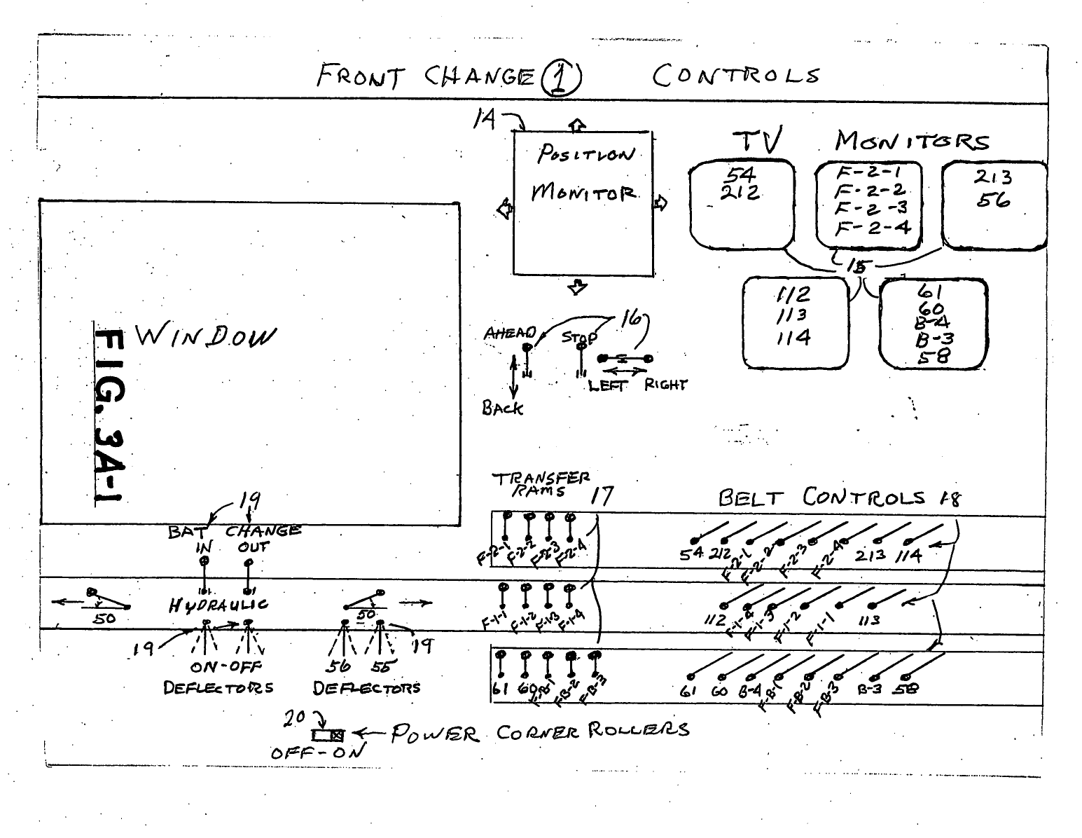

In FIG. 2 the opposite side of Electric Automobile/Special Power Source is shown in 10. This vehicle operates on a very efficient group of 20 lead-acid batteries. They are assembled in 4-5 battery Bat-Pac's. The key to the whole patent is the quick removal and quick installation of the 4 Bat-Pac's which allows for continuous operation with only minor time elapse during the change.

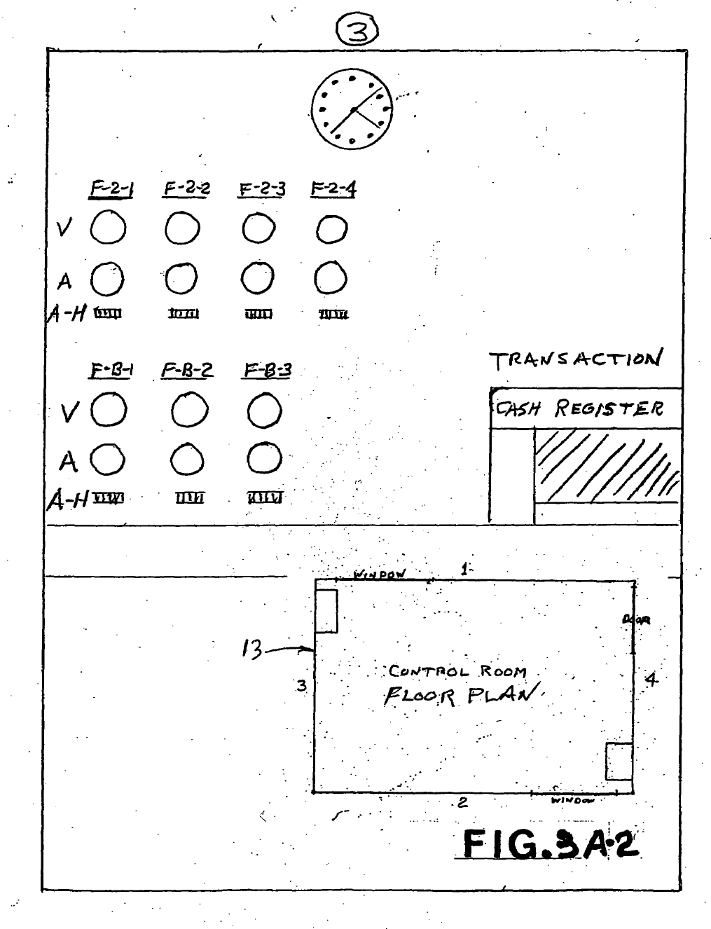

FIG. 3 displays the control room (11) which carries all the switching, monitoring, belt control, roller control with numerous electrical metering devices that enable the operator instant control of all equipment. The Control Room (11) is manned by a competent operator (12) shown in FIG. 3

FIG. 3A-1 shows the control arrangement in detail. The floor plan is shown at (13) lower right of FIG. 3A-2. It must be thoroughly understood that there are 2 different locations to withdraw and reinstall the Bat-Pac's. Front change control apparatus is shown and observed on wall 1, FIG. 3A-1. Wall 3 in FIG. 3A-2 has electrical instruments installed to observe. Charging information; i.e., A=Amps, V=Volts, A-H=Ampere-hours of charge assigned to each belt charge line.

FIG. 3B-1 on wall 2 shows rear change control apparatus same as with the front change. FIG. 3B-2 on Wall 4 has similar instruments to Wall 3. The,Control Room entry door is also located on Wall 4. Each belt is assigned a code number. As an example: F-2-4. F=Front, 2=2nd floor, 4=belt number.R-2-4: R=rear, 2=2nd floor, 4=belt number. Also, F-B-3 equates to F=front, B=basement, 3=belt number. Also, R-B-4 equates to R=rear, B=basement, 4=belt number. Other belt numbers are assigned to a multitude of transfer belts.

FIG. 3A-1 utilizes position monitor 14. TV monitor scopes all belts listed in 15. Switches 16 signal position of advancing Electric Automobile/Special Power Source left or right, ahead or back, or stop when at exchange station. 17 Controls all transfer rams. 18 Switches belt controls on or off. 19 Is the withdraw and install ram for the Bat-Pac's front change station. It also includes the deflectors. 20 Is the switch for corner power rollers.

A similar control series is present in FIG. 3B-1 which is the rear change control system.

In FIG. 7 it shows charged Bat-Pac's being transferred on 112 to any of four storage belts, F-t-4, F-1-3, F-1-2, F-1-1. Approximately 80+Bat-Pac's can be stored on the 1st floor storage area in front change section. Upon customer requirements Bat-Pac's are fed onto belt 113 and then to belt 50 to reinstall in Electric Automobile/Special Power Source. Each front installation requires 2 Bat-Pac's. This is also shown in FIG. 8 as 2 Bat-Pac's travel on 113 to 50.

FIG. 9A shows the rear Bat-Pac installation looking up from the bottom. Both Bat-Pac's are in view.

FIG. 9B shows the rear Bat-Pac removed.

FIG. 9C shows the front Bat-Pac removed.

FIG. 9D shows the bottom view of Electric Automobile/Special Power Source with both Bat-Pac's removed.

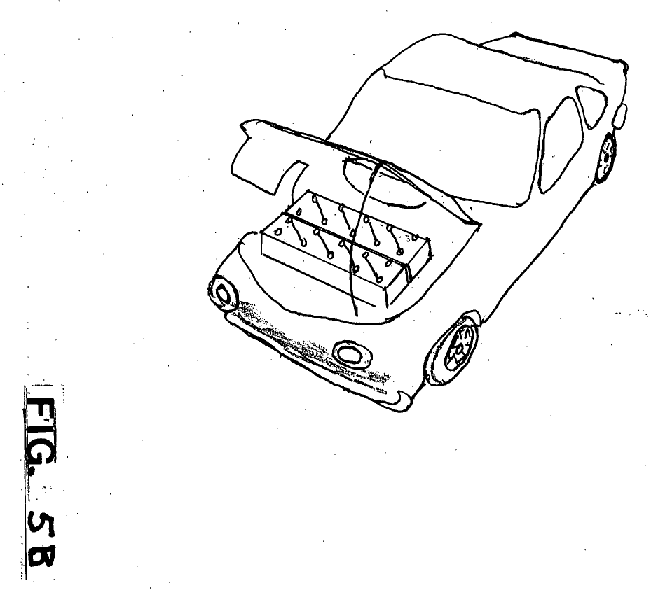

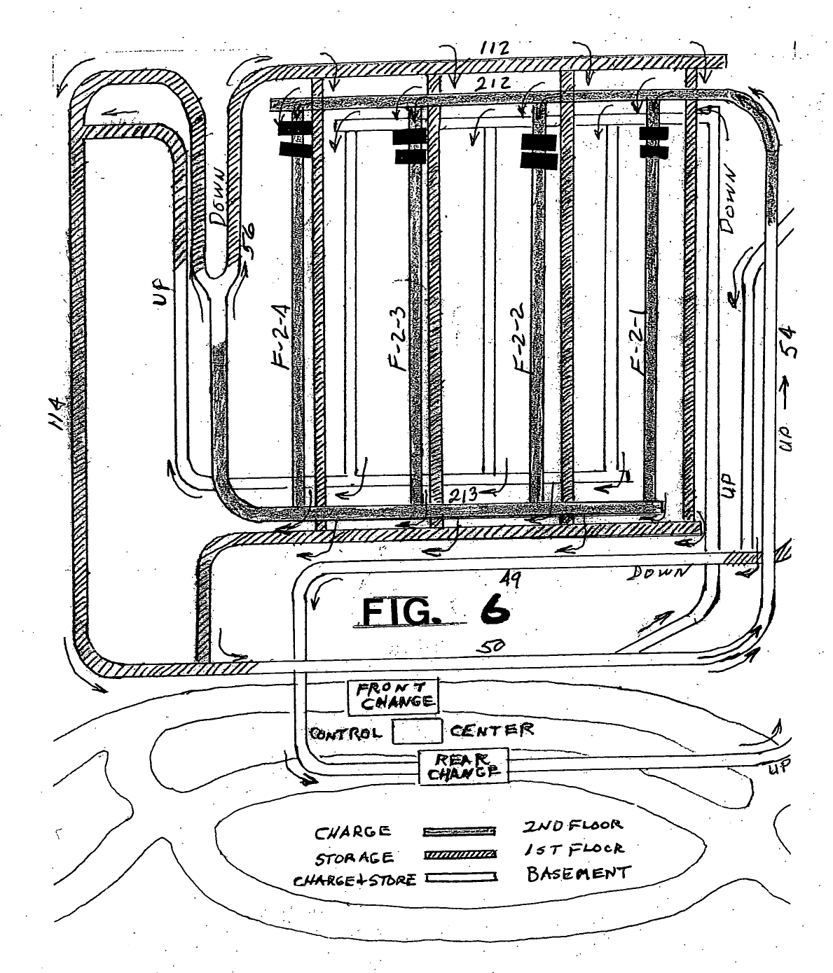

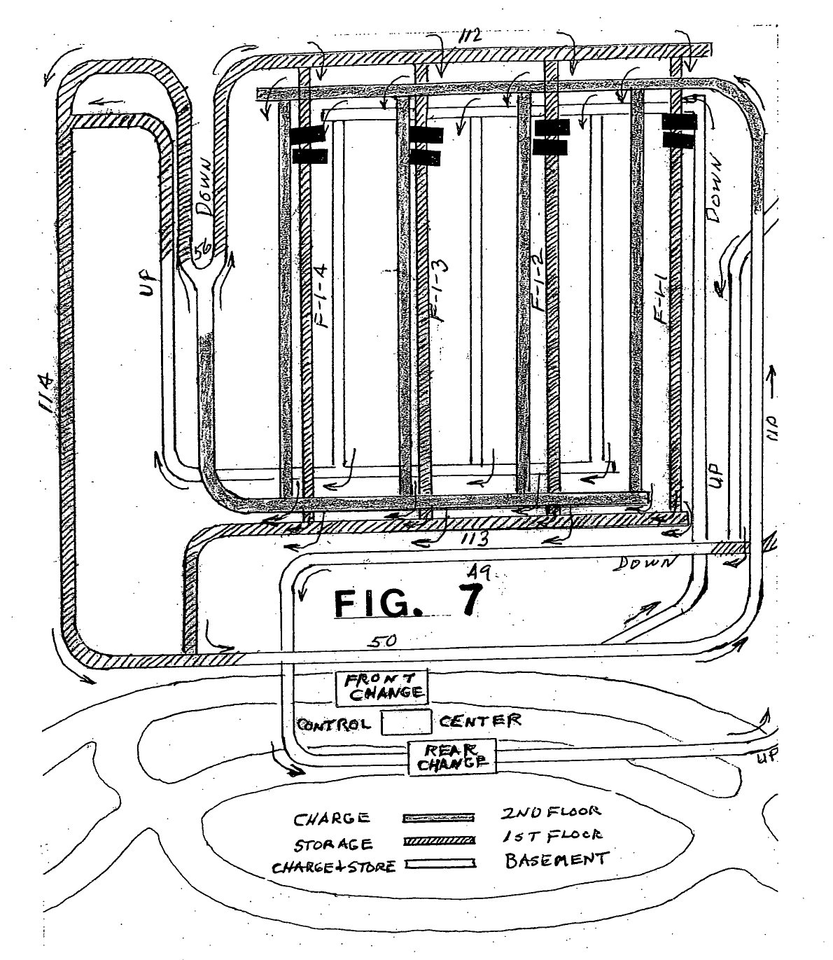

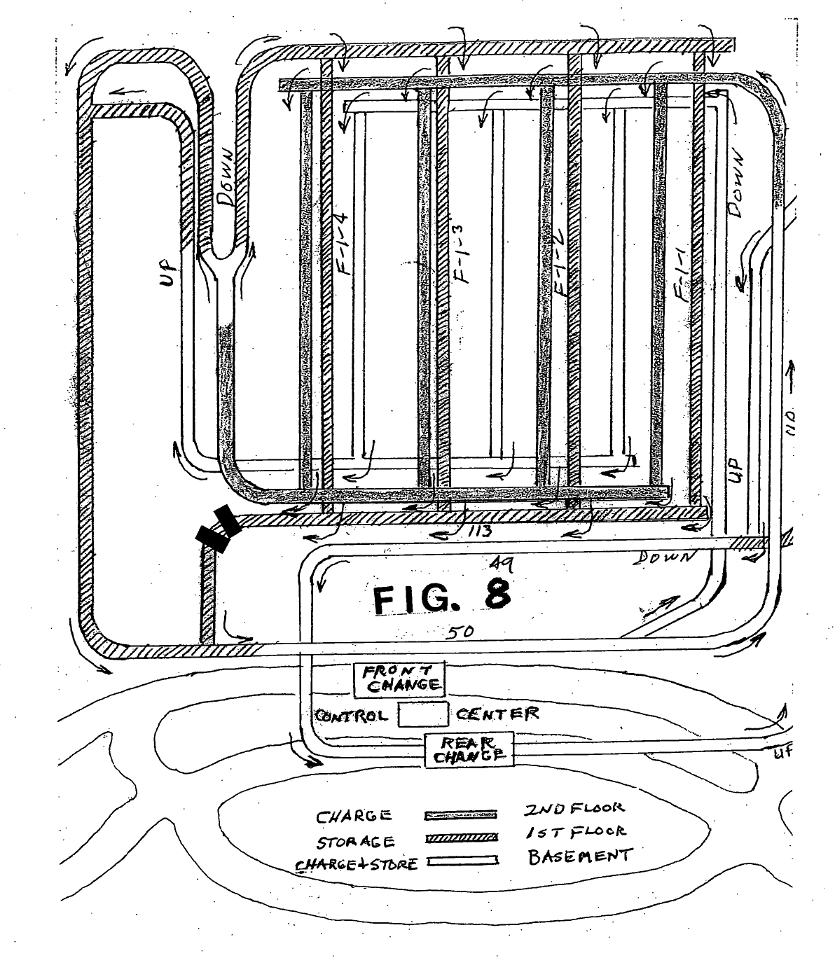

FIG. 10 follows the transfer of Bat-Pac's from the rear exchange. Belt 52 feeds 53 which feeds onto 210. At this point a selection occurs between charge belt R-2-1, R-2-2, R-2-3 and R-2-4. The transfer rams deliver the Bat-Pac's with deflectors orienting them relative to proper position at each charge station. After 6-8 hours charging each charge belt will feed the Bat-Pac's to 211 belt. From there they. will travel to the Y-split down 55 to 110. From 110 they are put in storage by transfer ram onto R-1-4, R-1-3, R-1-2 or R-1-1. This is shown in FIG. 11. All charged Bat-Pac's will then travel on 111 to 49. 49 Belt feeds 51 which then transfers Bat-Pac's onto the vertical hoist for rear installation. This is shown in FIG. 12.

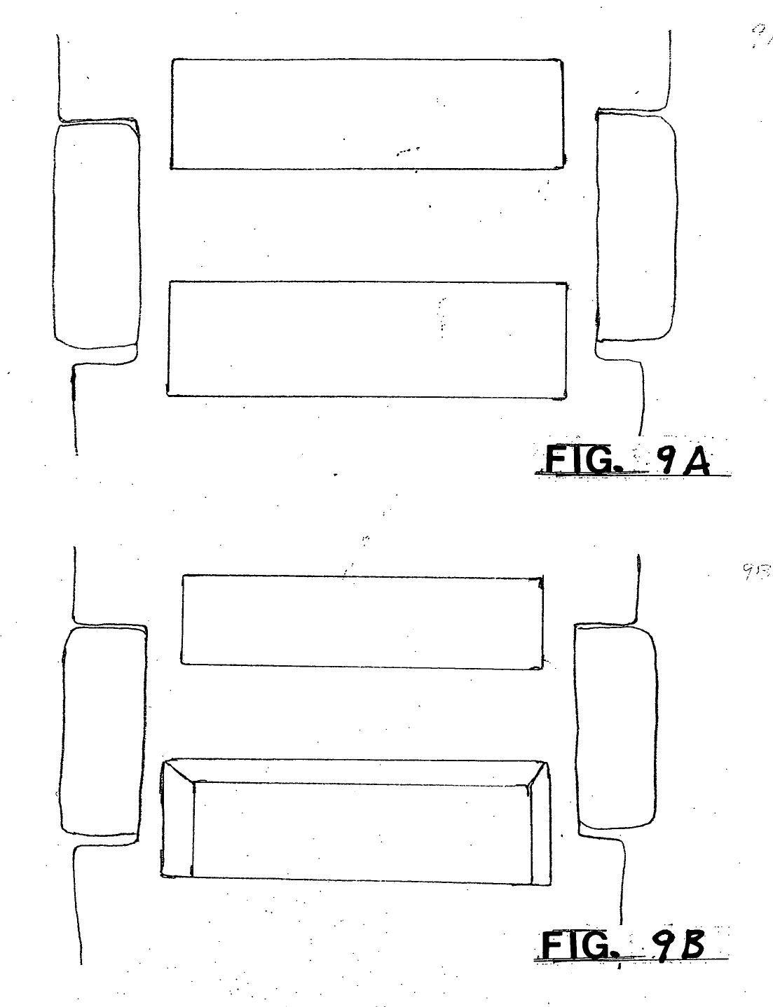

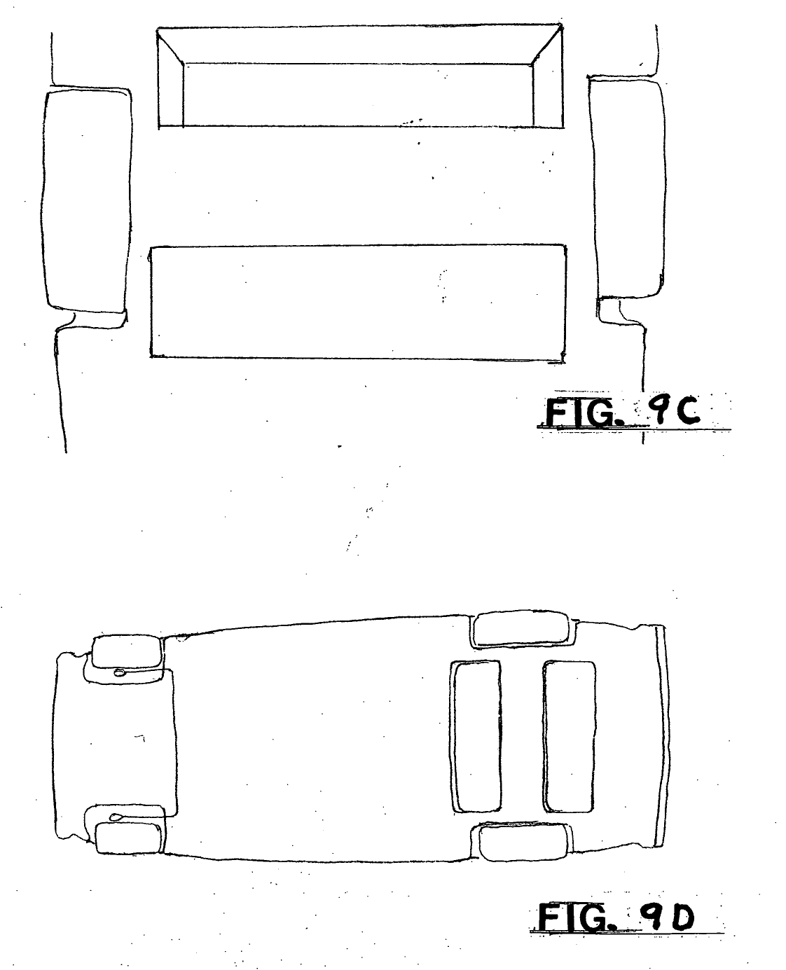

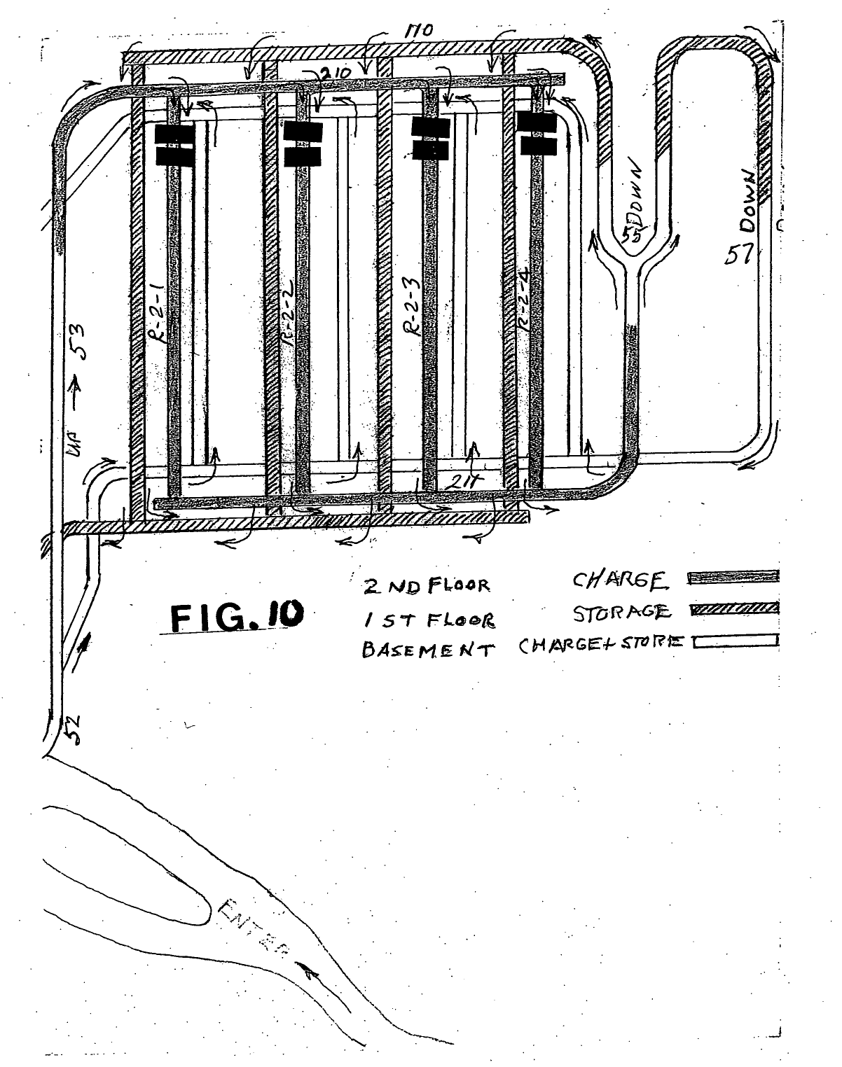

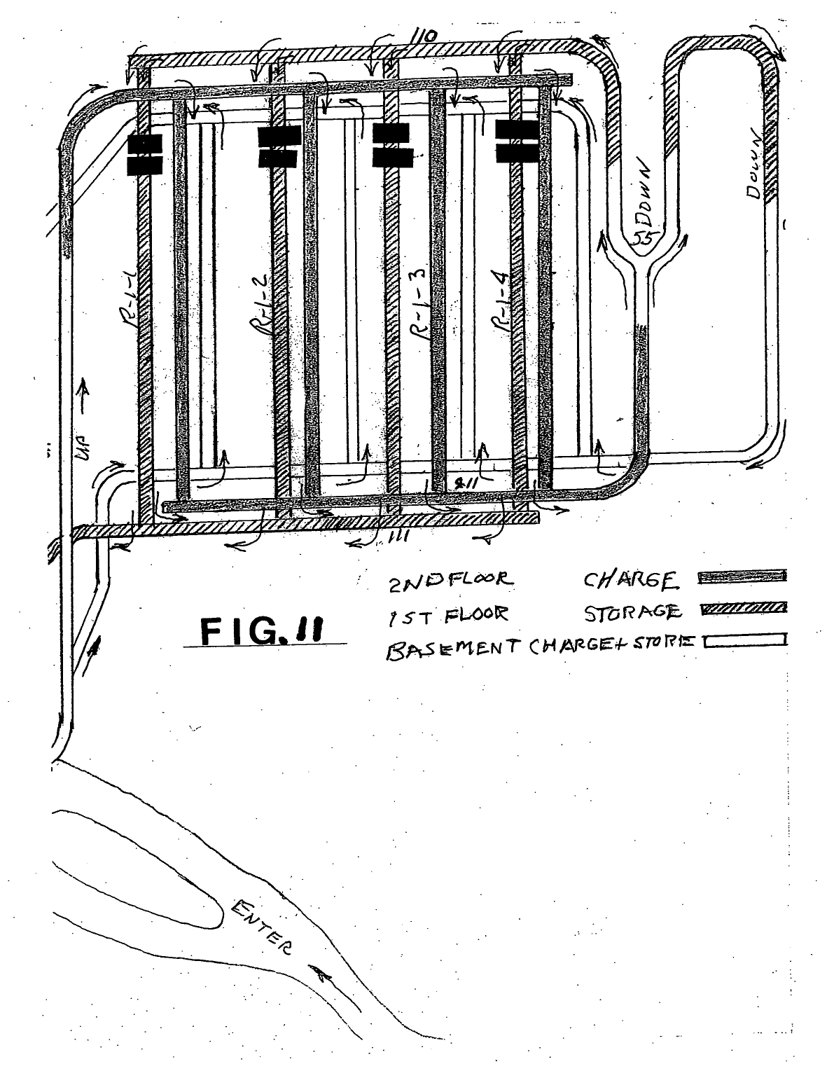

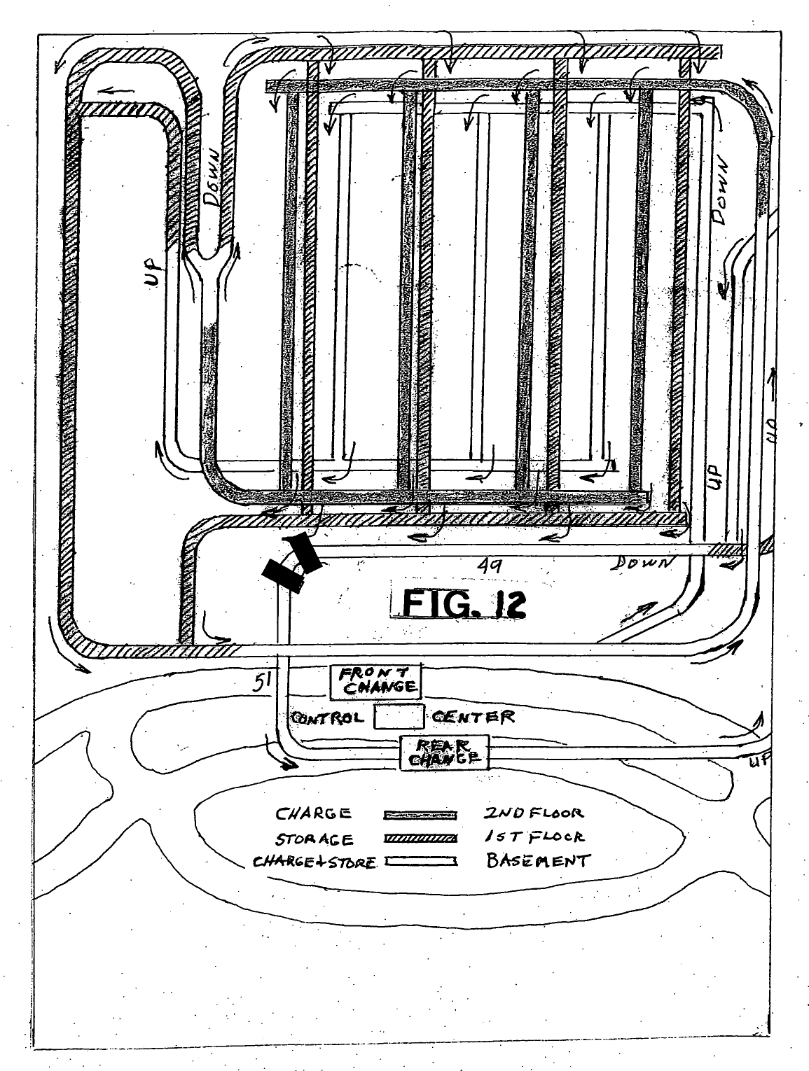

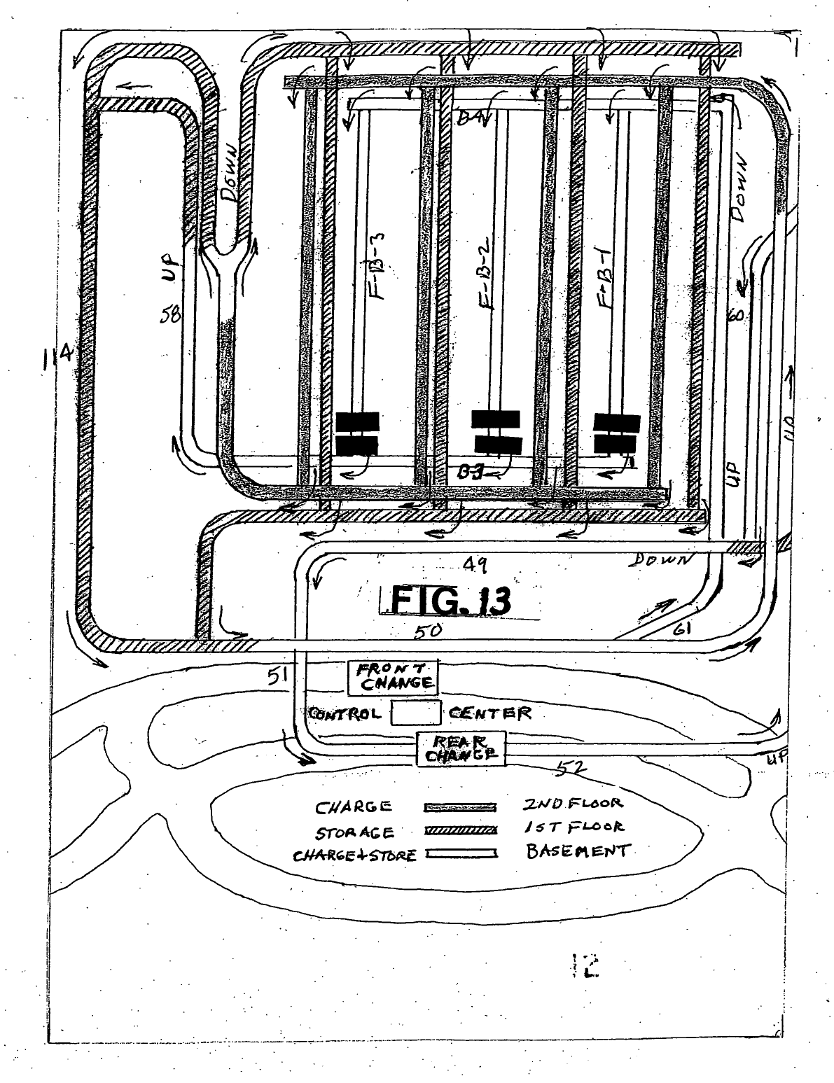

In FIG. 13 front change Bat-Pac's that are withdrawn are placed on belt 50 which feeds a diverter at 61. The Bat-Pac's then travel down 60 to B-4. They are then placed on F-B-1, F-B-2, F-B-3. These belts are part charge and part storage. Upon required use they travel on B-4 to 58 to 114 and to 50 for installation as demand occurs.

In FIG. 14 extracted Bat-Pac's travel on 52 to the diverter at 62. 62 feeds B-1. From B-1 all Bat-Pac's will be moved by a transfer ram onto R-B-1, R-B-2, R-B-3 or R-B-4. These are all rear change Bat-Pac's. Upon requirement they then are transferred to B-2. B-2 feeds 59-A which feeds 59-B. It then intersects 49 which feeds 51 and then onto the rear change hoist. as required.

FIG. 14A is an overview of the entire operation. This includes the Control Room, Front Change and Rear Change positions plus the entire belting and roller assembly. There are 2 floors plus a basement. The system should be extremely efficient.

21 is the position monitor. 22 is the monitor system for all belts listed. 23 is the control switches signaling an advancing Electric Automobile/Special Power Source into the exchange position. 24 Controls the rail pit cover shown in FIG. 3C-2. Again 25 shows transfer ram switches. 26 are belt control switches. 27 controls the hydraulic hoist on the rear change system coupled with deflectors.

28 controls all power roller circuits in area.

FIG. 3C-1 is a plan showing sensor layout which controls approaching Electric Automobile/Special Power Source positions.

FIG. 3C-2 another view with sensor layout. This view includes rail pit cover and rear hoist sketch.

FIG. 3C-3 shows a blowup of Control Room, front and rear exchange positions.

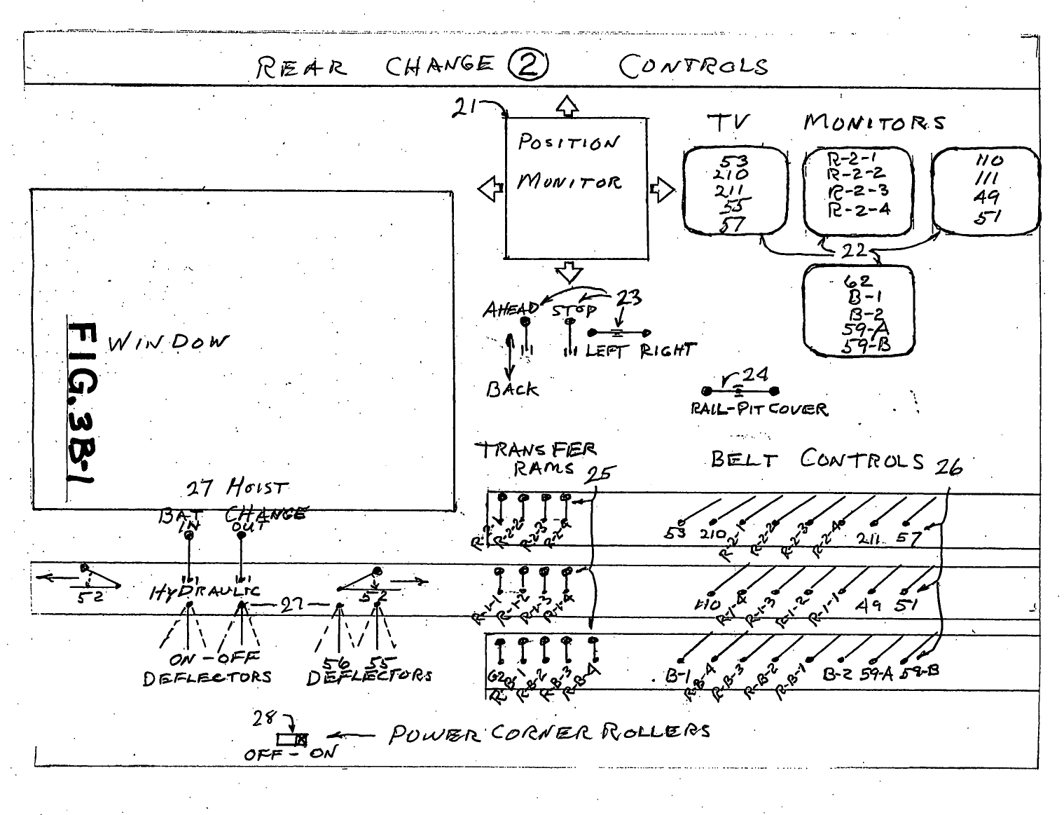

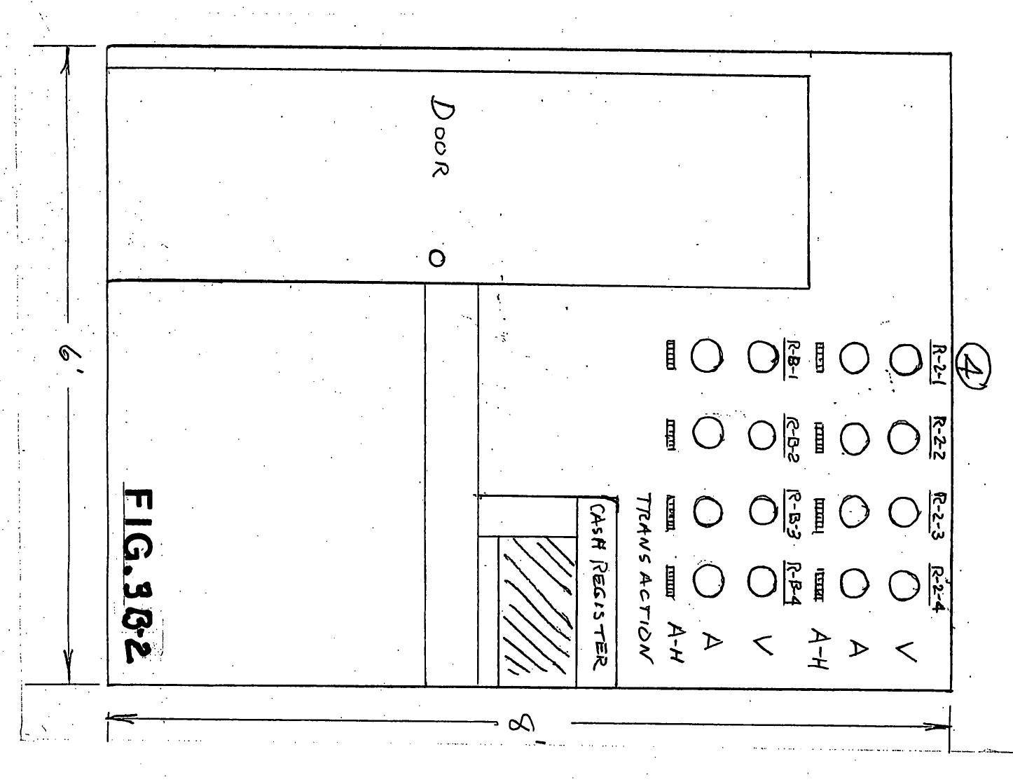

FIG. 4A is an excellent portrayal of withdrawal of the Bat-Pac's by hydraulic ram 29 using side front exchange.

FIG. 4B is replacing withdrawn Bat-Pac. 2 Bat-Pac's fit side by side in front of Electric Automobile/Special Power Source.

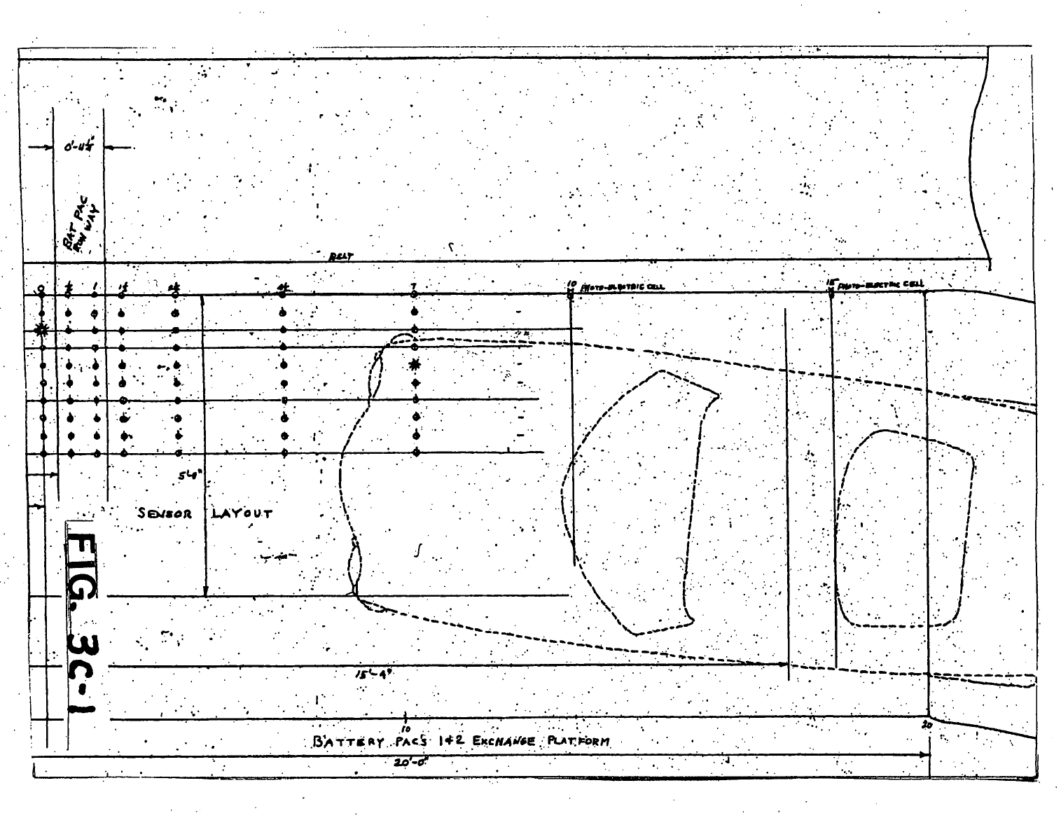

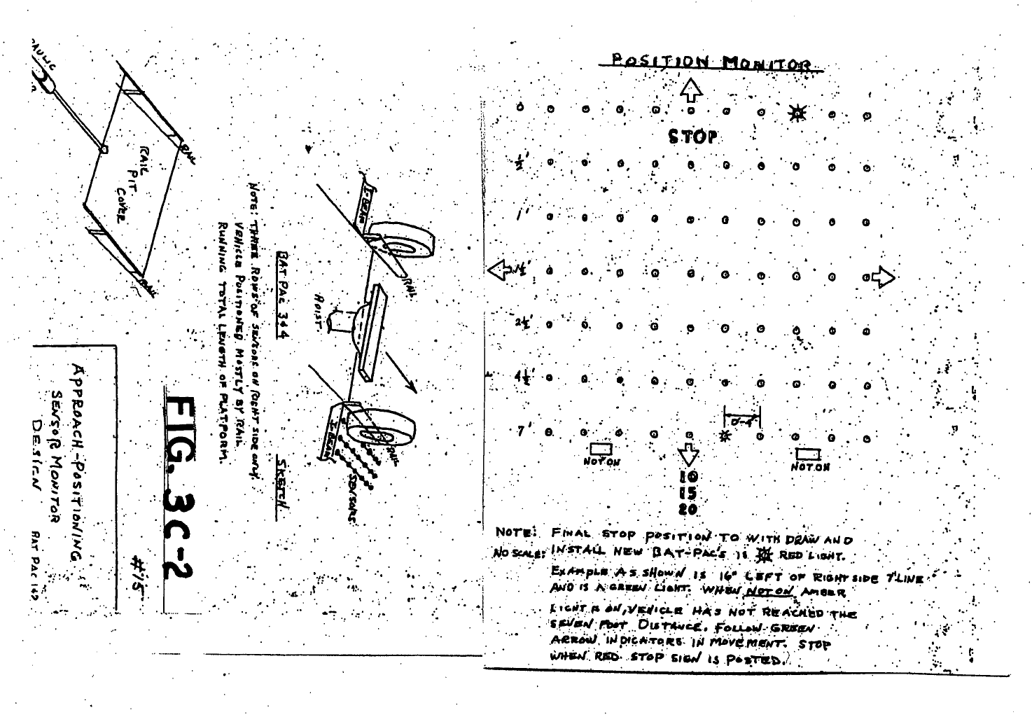

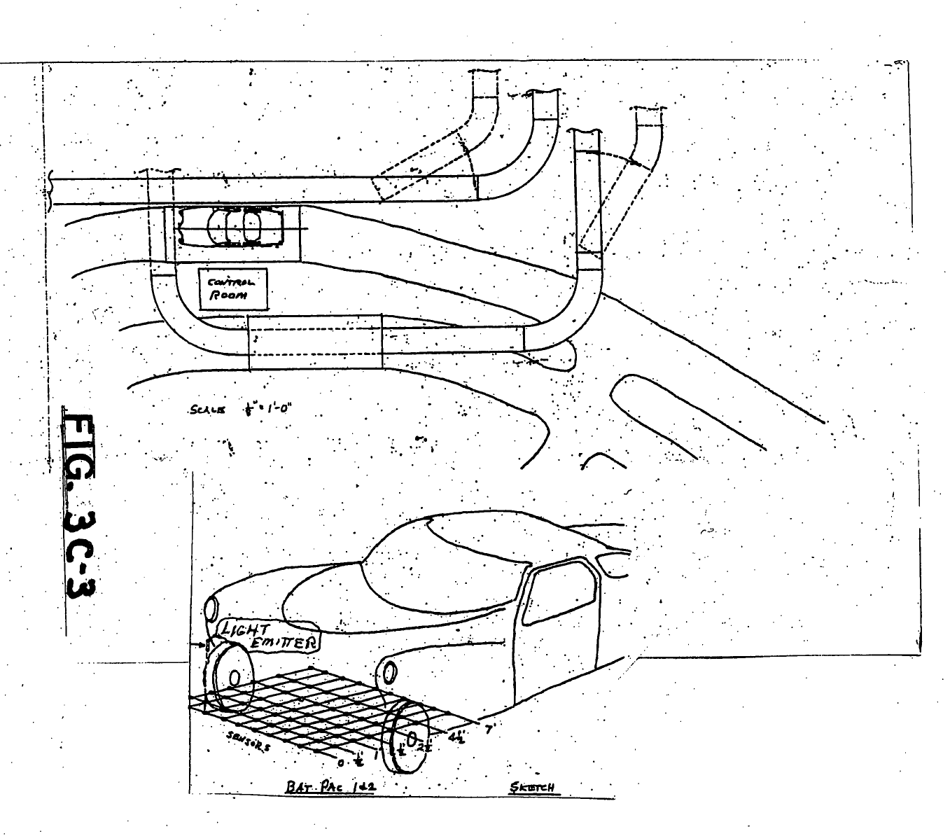

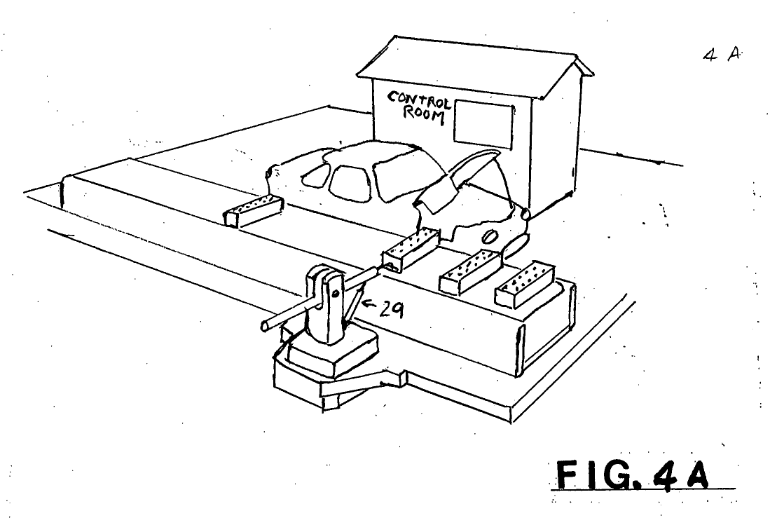

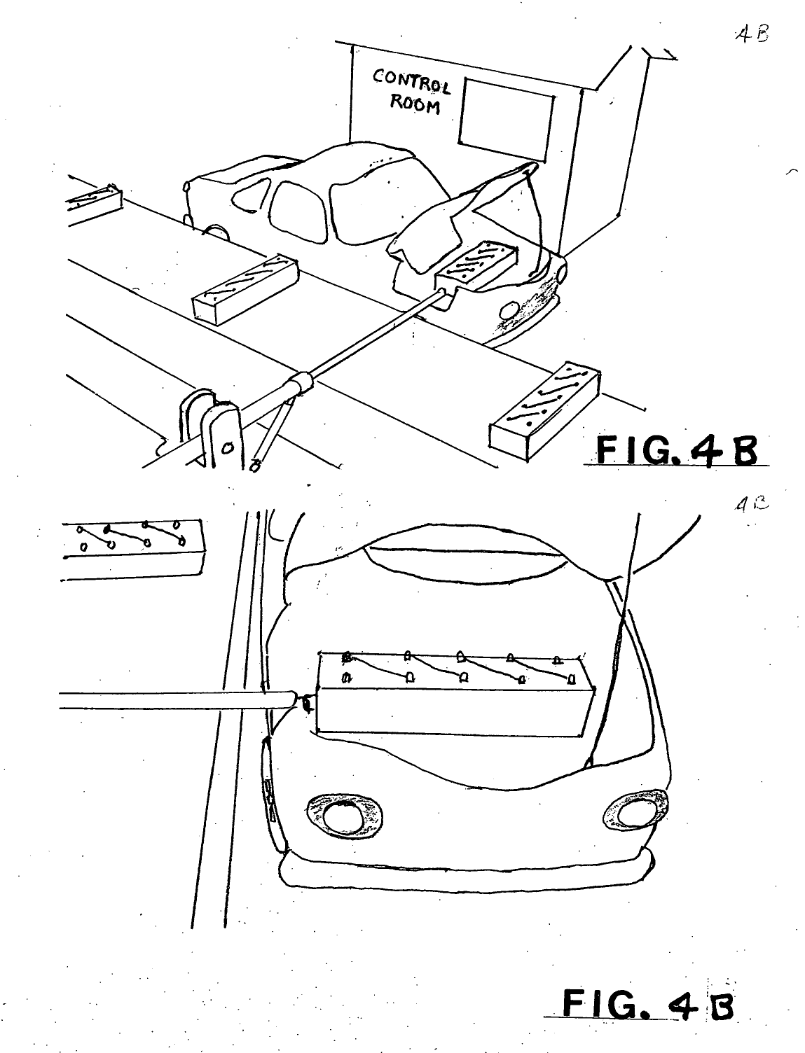

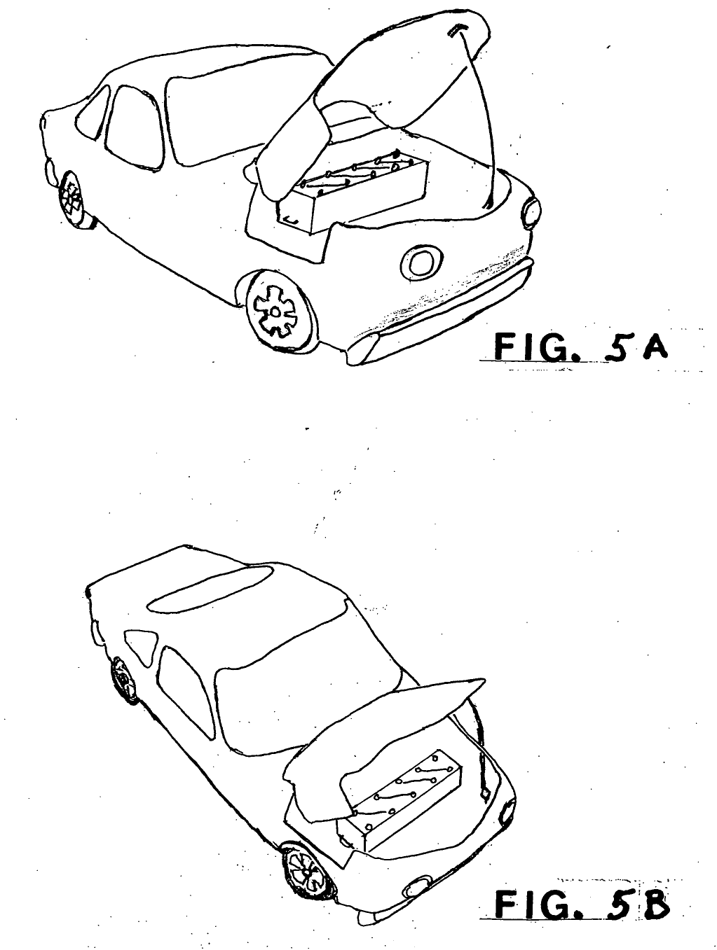

FIG. 5A shows another view of installed Bat-Pac.

FIG. 5B shows a view of the forward Bat-Pac. Also another view includes both front Bat-Pac's installed.

FIG. 6 shows belt transfer of discharged Bat-Pac's to second floor charging stations. Belt 50 feeds 54 up and then to 212. Then there are four choices depending on occupancy on the charging lines. Each charge line belt will handle approximately 20 Bat-Pac's or enough to supply 10 Electric Automobile/Special Power Source. FIG. 17 shows a charging station complete with connected terminals. Six to eight hours will be required to charge each Bat-Pac.

It will take some experience to be able to know the sequence of working out the timing between storage and charge line capacities. The transfer rams will push Bat-Pac's off of belt 212 onto the charge belts. The deflectors will correct the alignment. Also when charging is complete each charge belt feeds onto Belt 213 which will connect with a Y-split and with a deflector can direct the charged .Bat-Pac's down to 114 or 112. 114 will feed Electric Automobile/Special Power Source again from 50 with fresh Bat-Pac's.

FIG. 15 shows the front Bat-Pac arrangement that includes the connect-disconnect terminals and hydraulic ram attachment.

FIG. 16 shows the rear Bat-Pac design and.deployment. The hoist is shown plus connectdisconnect terminals are viewed.

FIG. 17 shows the front charge station apparatus including connect-disconnect terminals.

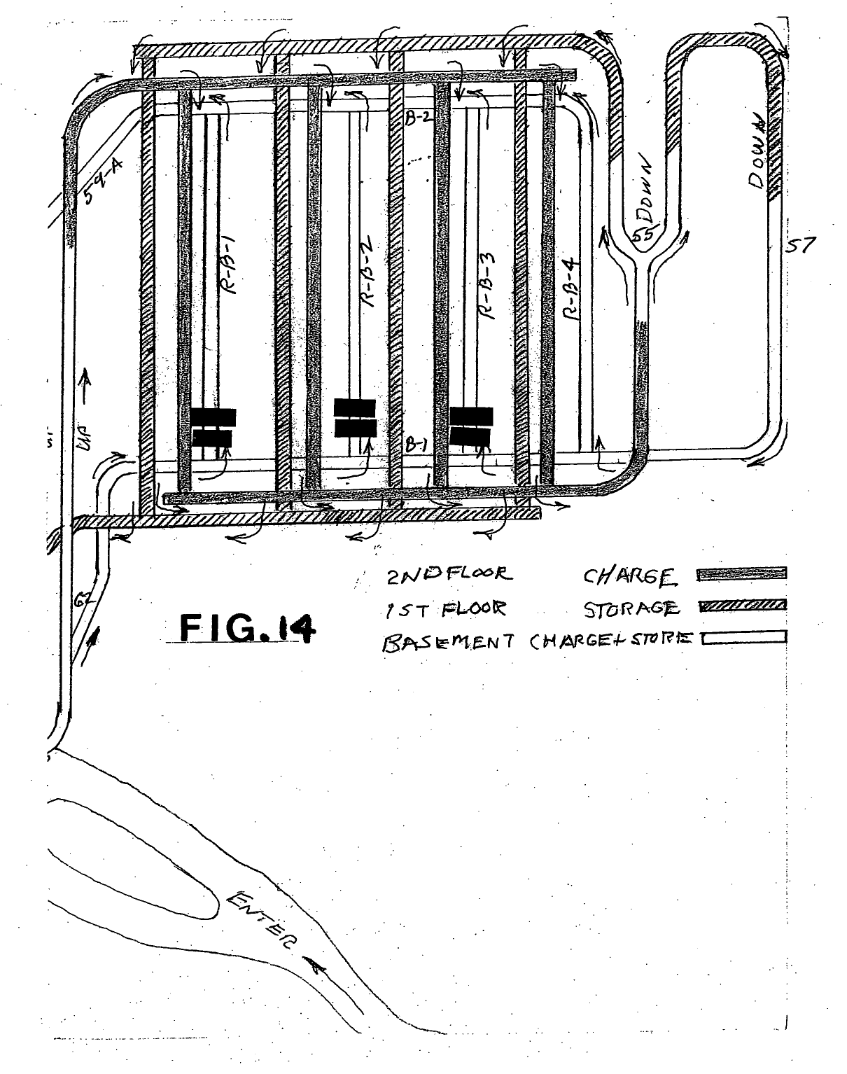

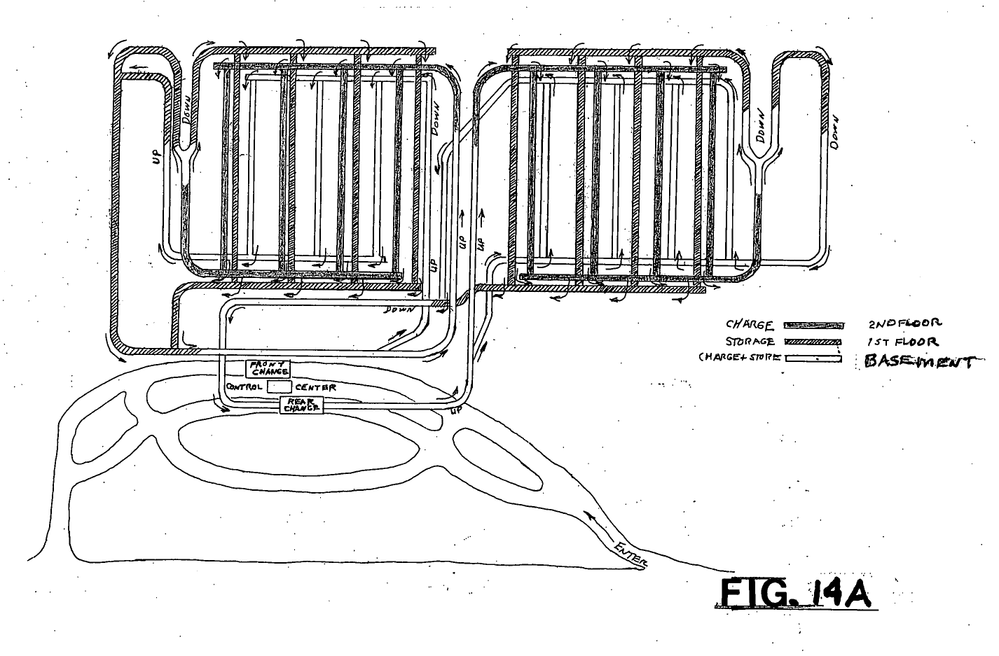

FIG. 18 views the rear charge station apparatus including connect-disconnect terminals.

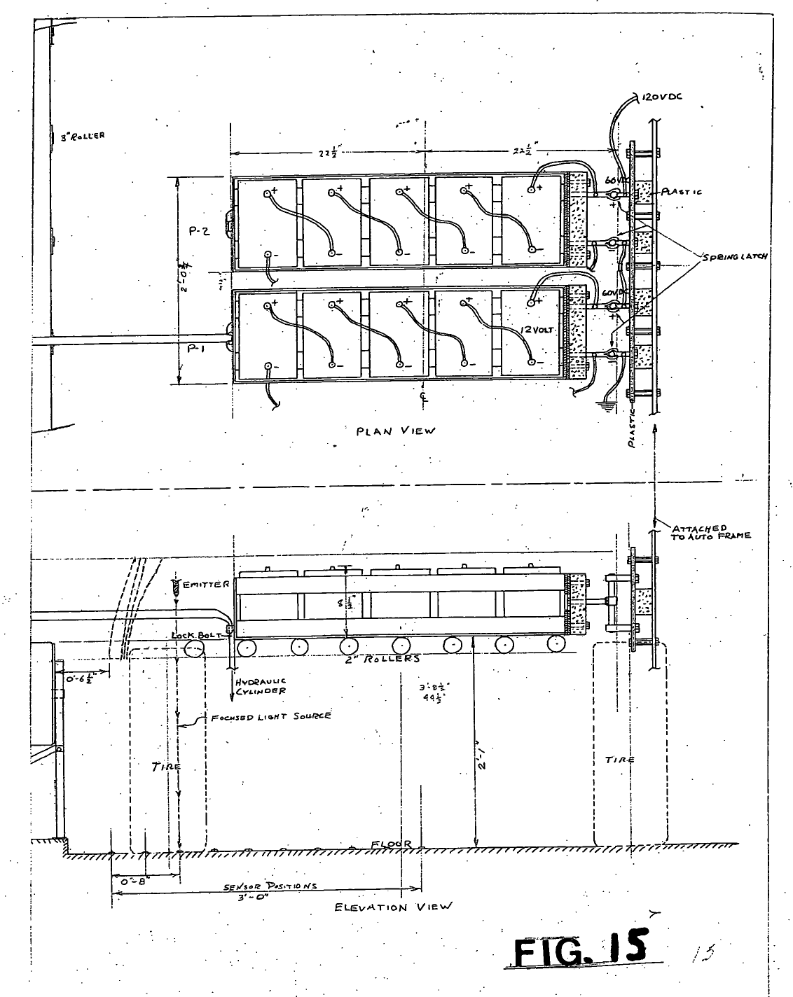

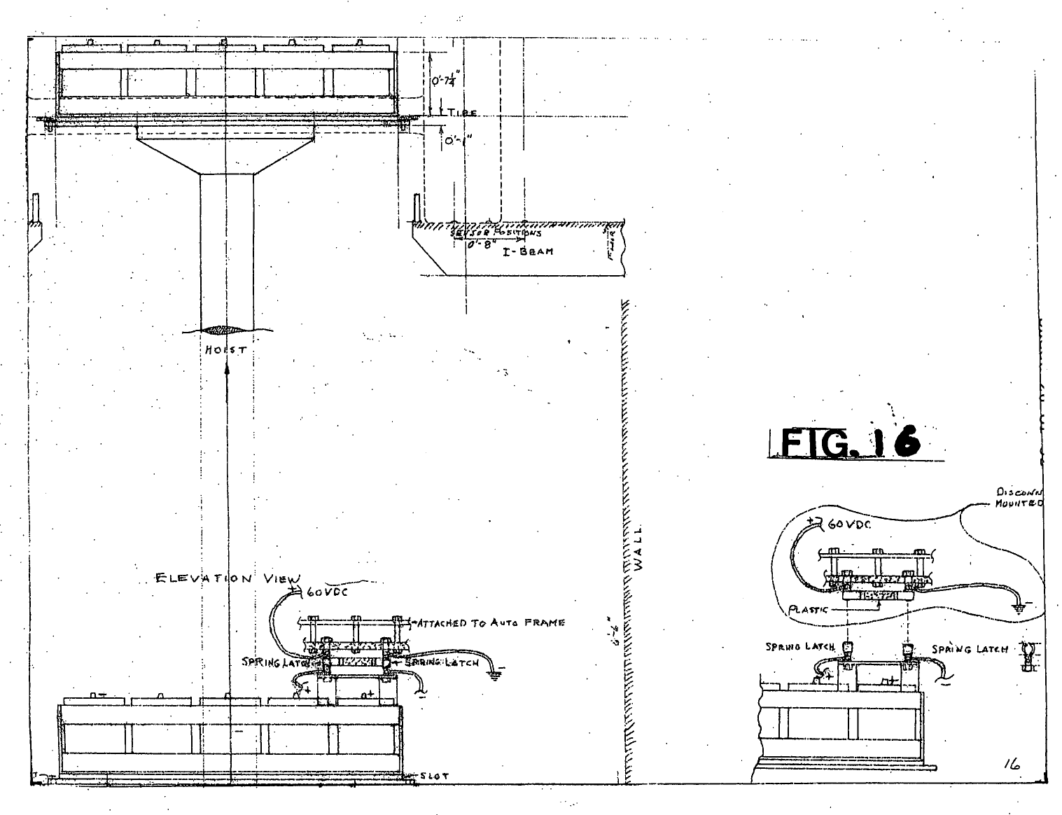

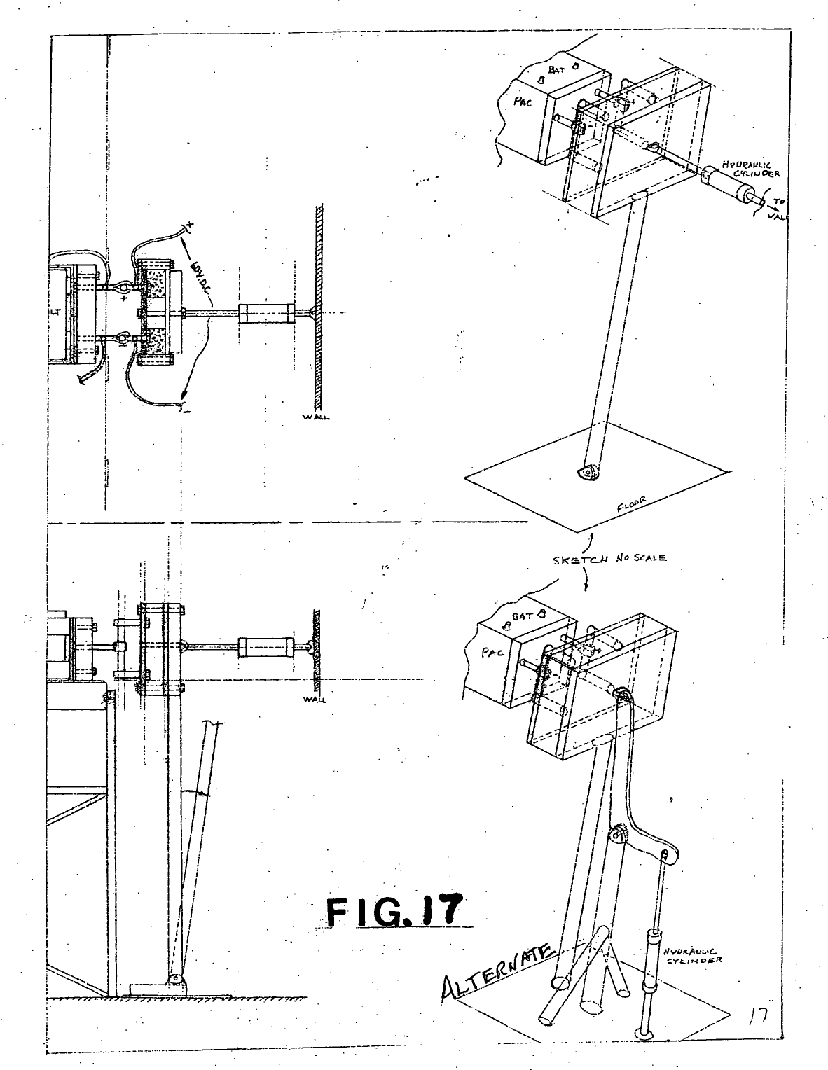

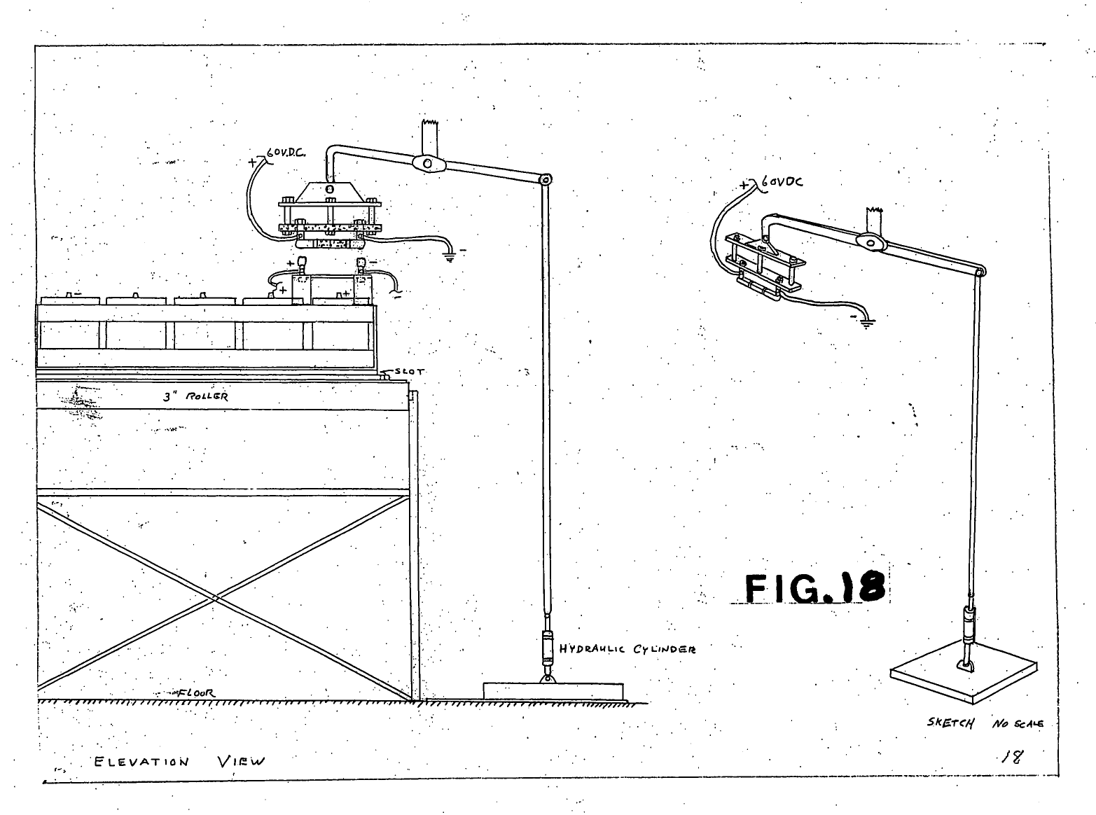

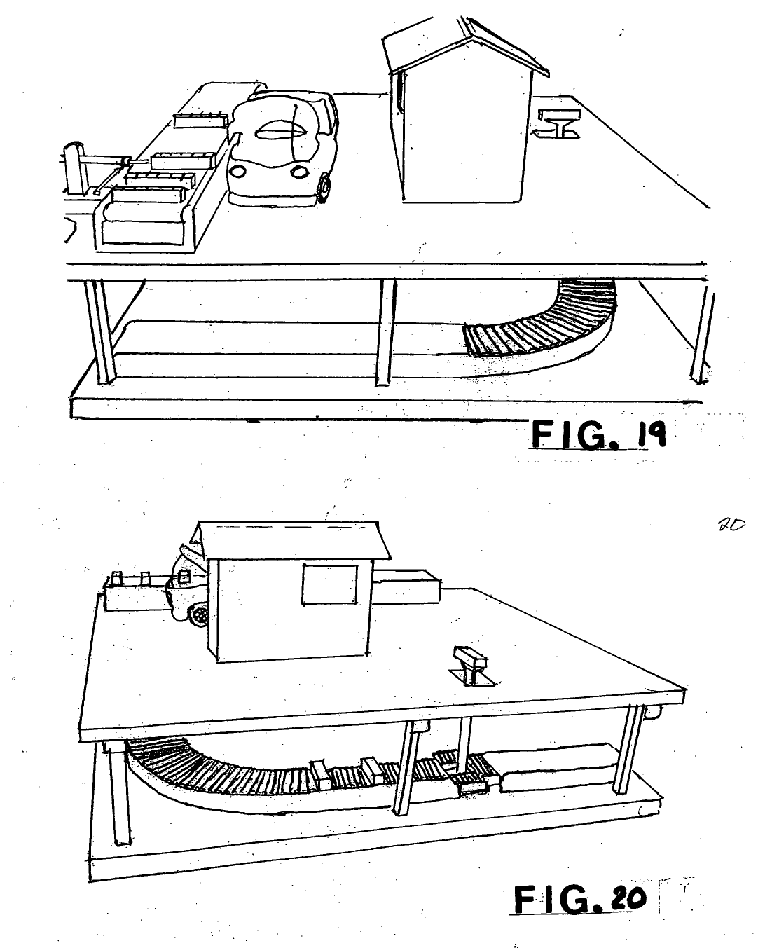

FIG. 19 is an isometric view of the Control Room plus belt 50 and the hydraulic. ram apparatus to withdraw and install Bat-Pac's in Electric Automobile/Special Power Source. The feed belt 51 is seen below plus power rollers. Also the hoist with a rear Bat-Pac can also be observed.

FIG. 20 is a similar view but rotated 90°.

FIG. 21 views Electric Automobile/Special Power Source positioned to receive a BatPac from the lower level.

FIG. 22 is another view of the same happening.

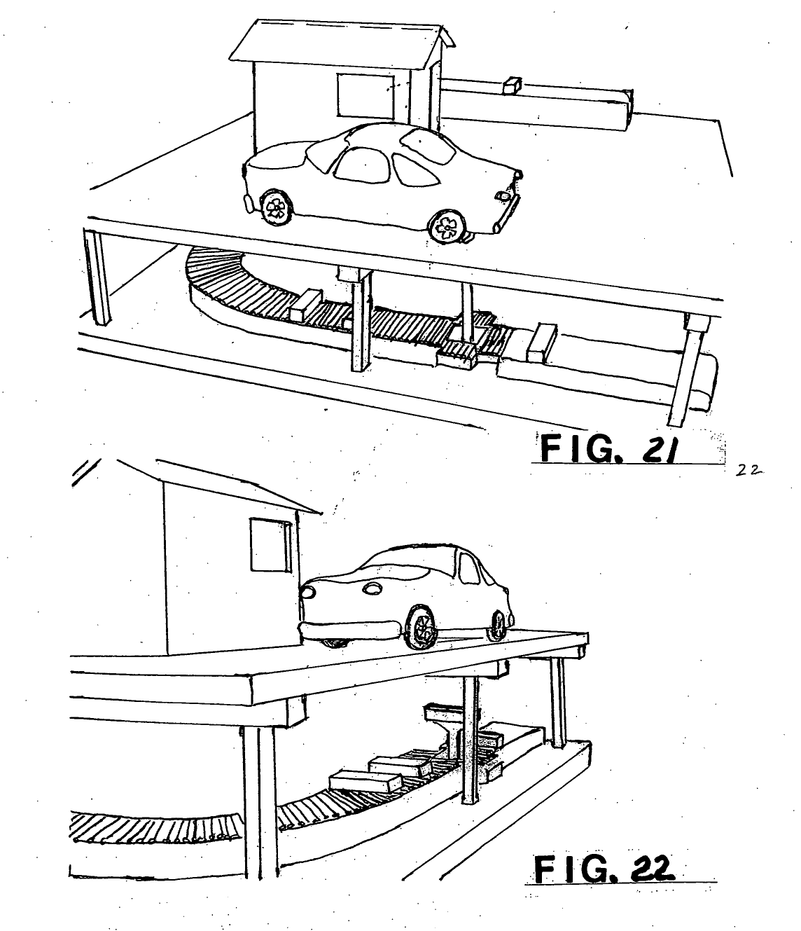

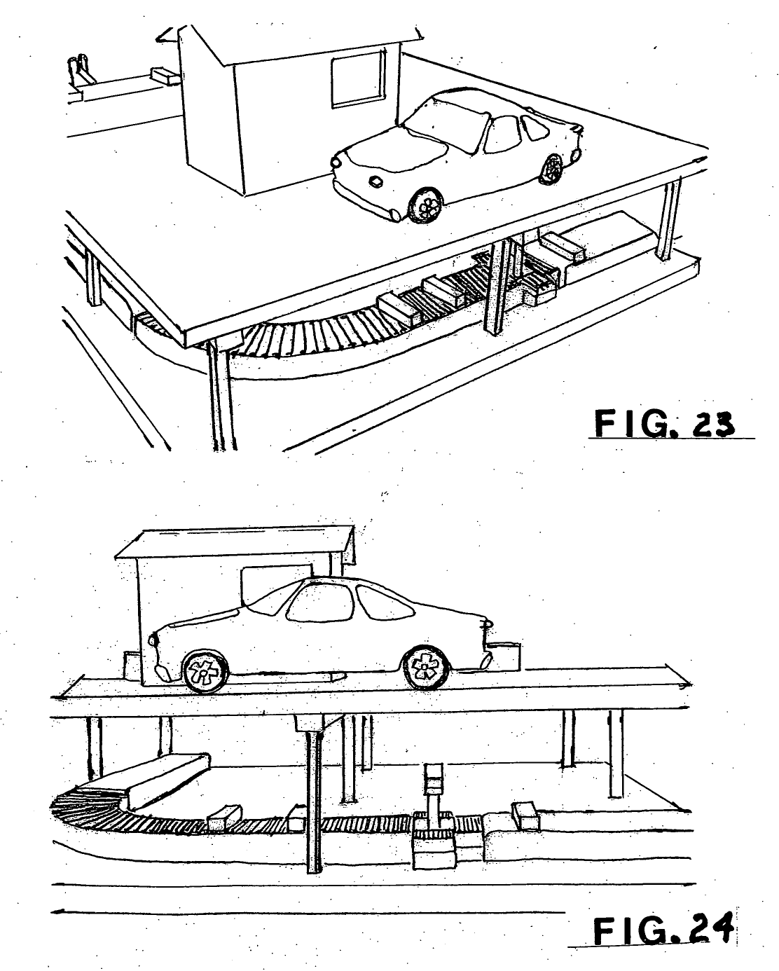

FIG. 23 shows the same occurence.

FIG. 24 is a side isometric view with Bat-Pac's being installed in rear compartment.

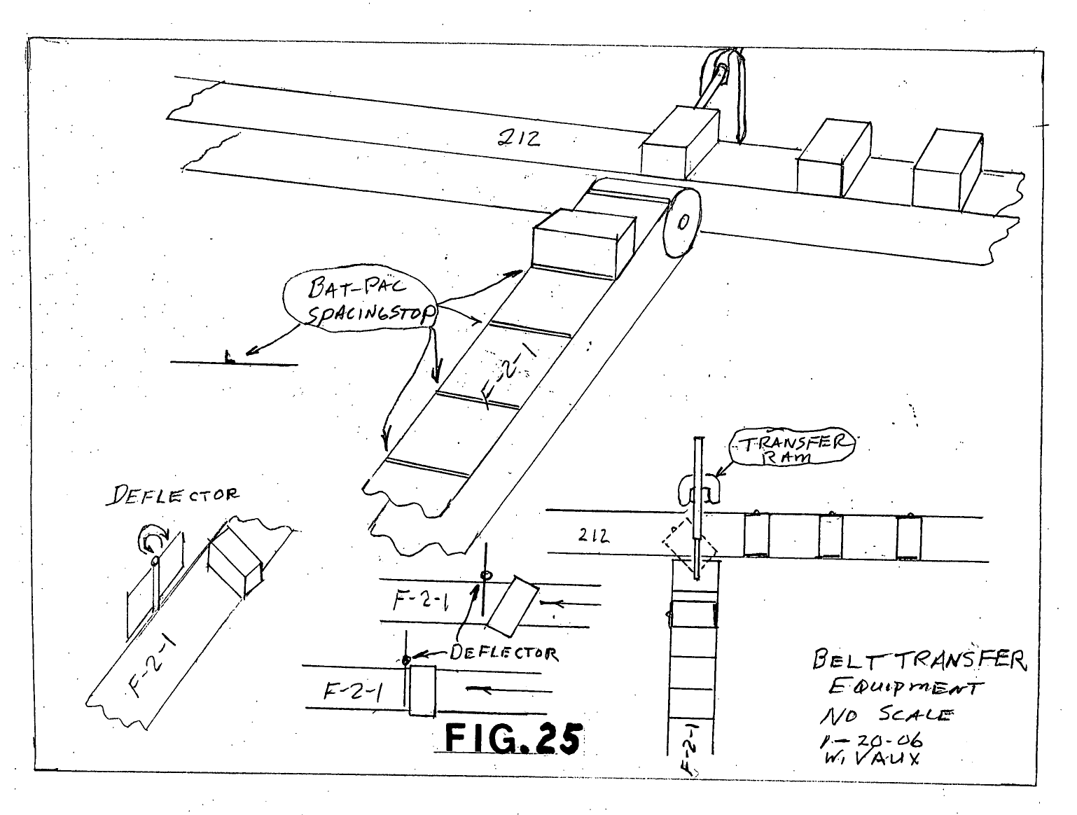

FIG. 25 shows a close up of a transfer ram moving Bat-Pac's from one belt to a belt which is 900 alignment in a different direction. The spacing stops are viewed approx. every 2′. The Bat-Pac's are aligned with deflectors as shown.

While it is realized that there is a very unique and complex system to accomplish the quick Bat-Pac exchange so many other elements are eliminated.

1. For example, there is no exploration for oil, gas or new coal resources.

2. There is no drilling for these resources.

3. There is no new refineries required.

4. Wind power will provide the source.

5. Solar power can help.

So therefore a new industry can be built and expanded on with projects like Electric Automobile/Special Power Source.

1. I claim the Electric Automobile/Special Power Source as being a process which eliminates the long wait to recharge the electric batteries in an electric automobile.

2. I claim the Bat-Pac Control Room (Center). This contains all the monitor controls, electrical meters and switch and power controls for belts, rollers, hydraulic rams, deflectors and misc. controls.

3. I claim the 3-story complex building which is designed to transfer discharged Bat-Pac's. Also transfer fresh recharged Bat-Pac's. Top floor is for charging stations. Middle or Ground Floor is to store recharged Bat-Pac's. Basement is to recharge and store Bat-Pac's.

4. I claim as outlined in claim 2, the electronic photo-electric auto positioner which precisely positions the electric auto for Bat-Pac removal and reinstallation with fresh batteries.

5. I claim as referenced in claim 3 a hydraulic ram installation of Bat-Pac equipment.

6. I claim as outlined in claim 3 the special connect-disconnect terminals which are utilized on the side exchange Bat-Pac's.

7. I claim as outlined in claim 1 the hoist system to lower and raise the rear bottom access Bat-Pac units.

8. I claim as in claim 1 the connect-disconnect terminals which are utilized at the rear bottom access Bat-Pac units.

9. I claim as outlined in claim 3 the interconnecting belt lines plus roller and power roller systems which allow this system to function.

10. I claim the design as mentioned in claim 1 of the charging units plus the connect-disconnect terminals.

11. I claim as outlined in claim 3 the utilization of the transfer rams which transfer a Bat-Pac from one belt onto another.

12. I claim as outlined in claim 3 the deflectors which orient the Bat-Pac's relative to connect-disconnect terminals.
